(19) United States
(12) Patent Application Publication
(10) Pub. No.: US 2017/0085697 A1
(43) Pub. Date: Mar. 23, 2017

(54) METHOD AND DEVICE FOR EXTENDING CALL FUNCTION

(71) Applicant: Xiaomi Inc., Beijing (CN)

(72) Inventors: Yin ZHU, Beijing (CN); Qian WANG, Beijing (CN); Lan LI, Beijing (CN)

(73) Assignee: Xiaomi Inc.

(21) Appl. No.: 15/257,174

(22) Filed: Sep. 6, 2016

(30) Foreign Application Priority Data
Sep. 17, 2015 (CN) 201510595610.5

(51) Int. Cl. H04M 1/725

(52) U.S. Cl. CPC H04M 1/72522; H04M 2250/68; H04M 2201/42

(57) ABSTRACT

A method for function extending includes displaying a call interface on a first terminal for a voice call with a second terminal, determining an extension function when detecting an extension operation performed on the call interface, and displaying an application interface corresponding to the extension function on the call interface.

### CROSS-REFERENCE TO RELATED APPLICATION

This application is based upon and claims priority to Chinese Patent Application No. 201510595610.5, filed on Sep. 17, 2015, the entire contents of which are incorporated herein by reference.

### TECHNICAL FIELD

The present disclosure generally relates to communication and, more particularly, to a method and device for function extending.

### BACKGROUND

With the continuous development of communication technology, smart terminals have been used more and more widely and provide more and more functions. For example, when a user uses a smart terminal to make a phone call, the user may need to record the content of the call, or may need to inform the other (called) party of his/her location information. In conventional technologies, when the user is on a call and needs to perform another task during the call, generally the user needs to put the current call to the background and then open the application corresponding to the other task.

### SUMMARY

In accordance with the present disclosure, there is provided a method for function extending including displaying a call interface on a first terminal for a voice call with a second terminal, determining an extension function when detecting an extension operation performed on the call interface, and displaying an application interface corresponding to the extension function on the call interface.

Also in accordance with the present disclosure, there is provided a terminal including a processor and a memory storing instructions that, when executed by the processor, cause the processor to: display a call interface on the terminal for a voice call with another terminal, determine an extension function when detecting an extension operation performed on the call interface, and display an application interface corresponding to the extension function on the call interface.

Also in accordance with the present disclosure, there is provided a non-transitory computer-readable storage medium having stored therein instructions that, when executed by a processor of a terminal, cause the terminal to display a call interface on the terminal for a voice call with another terminal, determine an extension function when detecting an extension operation performed on the call interface, and display an application interface corresponding to the extension function on the call interface.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate embodiments consistent with the invention and, together with the description, serve to explain the principles of the invention.

FIG. 1 is a flow chart of a method for call function extending according to an exemplary embodiment.

FIG. 2 is a flow chart showing an example of a process of determining an extension function in FIG. 1.

FIG. 3 is a flow chart showing an example of a process of determining the extension function according to a preset binding relationship in FIG. 2.

FIG. 4 is a flow chart showing an example of a process of displaying an application interface in FIG. 1.

FIG. 5A is a flow chart showing an example of a process of calling the extension function and displaying the application interface in FIG. 4.

FIG. 5B is a flow chart showing an additional process after a process of calling an information recording function and displaying an information recording interface in FIG. 5A.

FIG. 6A is a flow chart showing another example of the process of calling the extension function and displaying the application interface in FIG. 4.

FIG. 6B is a flow chart showing additional processes after a process of calling a location sharing function and displaying a location sharing interface in FIG. 6A.

FIG. 7A is a schematic diagram showing an application scenario according to an exemplary embodiment.

FIG. 7B is a schematic diagram showing a call interface according to an exemplary embodiment.

FIG. 7C is a schematic diagram showing an information recording interface according to an exemplary embodiment.

FIG. 7D is a schematic diagram showing a note reminder according to an exemplary embodiment.

FIG. 7E is a schematic diagram showing a location sharing interface with a geographic location of a first terminal according to an exemplary embodiment.

FIG. 7F is a schematic diagram showing a sharing prompt according to an exemplary embodiment.

FIG. 7G is a schematic diagram showing the location sharing interface with a geographic location of a second terminal according to an exemplary embodiment.

FIG. 8 is a block diagram of a device for function extending according to an exemplary embodiment.

FIG. 9A is a block diagram showing an example of an extension function determining module in the device shown in FIG. 8.

FIG. 9B is a block diagram of a device for function extending according to another exemplary embodiment.

FIG. 10 is a block diagram showing an example of an extension function determining sub-module in the extension function determining module shown in FIG. 9A.

FIG. 11 is a block diagram showing an example of a second displaying module in the device shown in FIG. 8.

FIG. 12A is a block diagram showing an example of a displaying sub-module in the second displaying module shown in FIG. 11.

FIG. 12B is a block diagram showing another example of the displaying sub-module in the second displaying module shown in FIG. 11.

FIG. 13 is a block diagram showing another example of the displaying sub-module in the second displaying module shown in FIG. 11.

FIG. 14 is a block diagram showing another example of the displaying sub-module in the second displaying module shown in FIG. 11.

FIG. 15 is a block diagram showing another example of the displaying sub-module in the second displaying module shown in FIG. 11.

FIG. 16 is a block diagram showing an example of a third displaying unit in the displaying sub-module shown in FIG. 15.

FIG. 17 is a block diagram of a terminal for function extending according to an exemplary embodiment.

### DETAILED DESCRIPTION

Reference will now be made in detail to exemplary embodiments, examples of which are illustrated in the accompanying drawings. The following description refers to the accompanying drawings in which the same numbers represent the same or similar elements unless otherwise represented. The implementations set forth in the following description of exemplary embodiments do not represent all implementations consistent with the disclosure. Instead, they are merely examples of devices and methods consistent with aspects related to the invention as recited in the appended claims.

Terms used herein in the description of the present disclosure are only for the purpose of describing specific embodiments, but should not be construed to limit the present disclosure. As used in the description of the present disclosure and the appended claims, “a” and “an” in singular forms also include plural forms, unless clearly indicated in the context otherwise. It should also be understood that, as used herein, the term “and/or” represents and contains any one and all possible combinations of one or more associated listed items.

It should be understood that, although terms such as “first,” “second,” and “third” are used herein for describing various information, such information should not be limited by these terms. These terms are only used for distinguishing information of the same type. For example, first information may also be referred to as second information, and similarly, the second information may also be referred to as the first information, without departing from the scope of the present disclosure. As used herein, the term “if” may be construed to mean “when” or “upon” or “in response to determining,” depending on the context.

Methods and devices consistent with the present disclosure can be implemented, for example, in a first terminal, which can be in a voice call session with a second terminal. The first and second terminals can both be smart terminals that have a network access function, each of which can be, for example, a mobile phone, a tablet, a personal digital assistant (PDA), a personal computer (PC), and can access a router via a wireless local area network and further access a server on a public network.

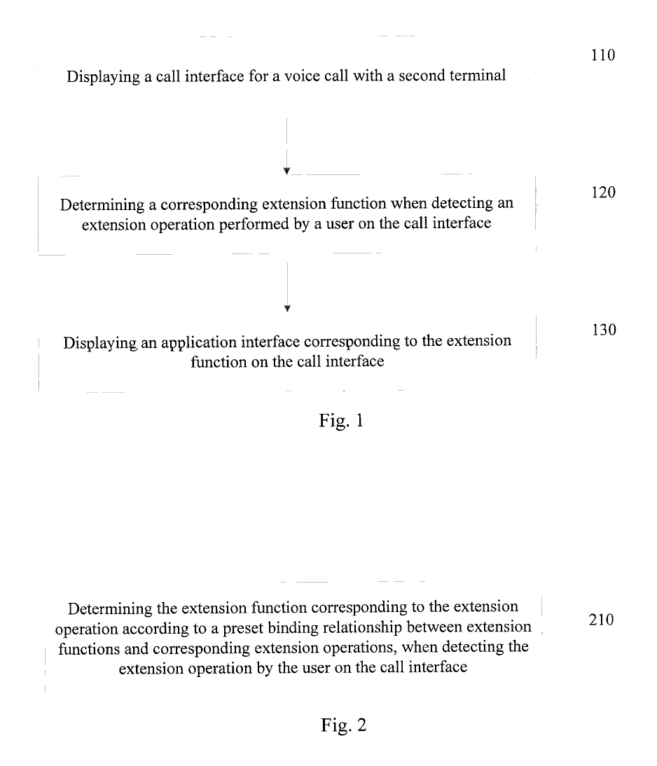

FIG. 1 is a flow chart of a method for call function extending according to an exemplary embodiment. Specifically, an extension function can be displayed and associated operations can be performed. In the present disclosure, the extension function refers to a function based on the voice call function of the first terminal, i.e., an extension of the voice call function of the first terminal.

As shown in FIG. 1, at 110, a call interface for a voice call with the second terminal is displayed. That is, when the first terminal receives the call from the second terminal, the first terminal displays the call interface for the call between the first terminal and the second terminal on a screen of the first terminal.

At 120, a corresponding extension function is determined when an extension operation performed by a user of the first terminal on the call interface is detected. For example, the user may need to record content of the call, also referred to herein as “call content,” or may need to inform the other party i.e., the caller using the second terminal, of the user's location information. The first terminal can provide the corresponding extension function to the user. The user can trigger the extension function via the extension operation corresponding to the answer extension function.

The extension operation can be, for example, a sliding operation, such as a leftward sliding, a rightward sliding, an upward sliding, or a downward sliding. For example, if the user needs to record the call content, the user can slide leftward on the call interface to trigger a corresponding information recording function.

At 130, an application interface corresponding to the extension function is displayed on the call interface. That is, after the extension function corresponding to the user's extension operation is determined, the corresponding interface can be directly displayed on the call interface.

For example, if the extension function is determined to be the information recording function, the information recording interface, e.g., a note-taking interface, can be displayed on the call interface. Thus, the user can conveniently record information during the call.

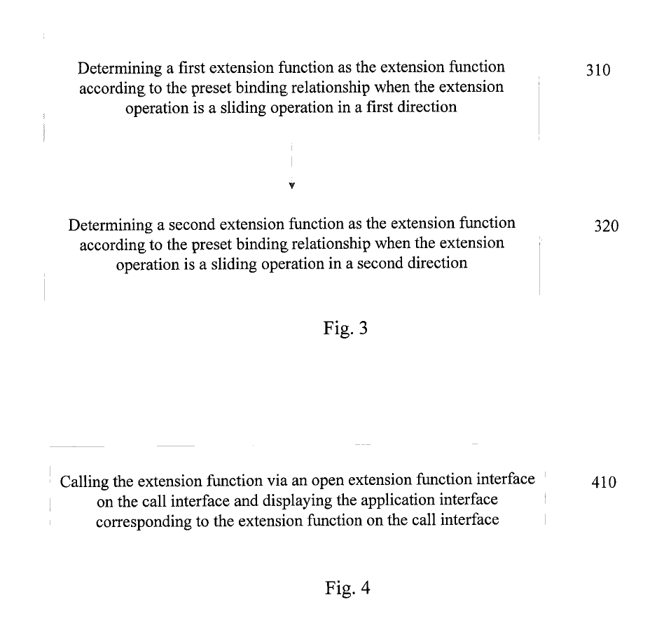

FIG. 2 is a flow chart showing an example of process 120 in FIG. 1. As shown in FIG. 2, at 210, the extension function corresponding to the detected extension operation is determined according to a preset binding relationship between extension functions and corresponding extension operations, when the extension operation by the user on the call interface is detected.

The preset binding relationship between extension functions and corresponding extension operations can be set in the first terminal in advance. For example, the binding relationship can be set by setting at least one extension function, setting an extension operation corresponding to each of the at least one extension function, and binding each of the at least one extension function with the corresponding extension operation to obtain the preset binding relationship.

In some embodiments, the first terminal can set a plurality of extension functions, such as an information recording function and a location sharing function. The first terminal can set the extension operation corresponding to each of the answer extension functions according to the design of the first terminal or according to the user's use habits. For example, the leftward sliding can be set as the extension operation corresponding to the information recording function, and rightward sliding can be set as the extension operation corresponding to the location sharing function. The preset binding relationship can be stored in a local database of the first terminal in the form of a table, such as Table 1 below.

TABLE 1

| Terminal name | Extension operation | Extension function |
|---|---|---|
| First terminal | Leftward sliding | Information recording |
| First terminal | Rightward sliding | Location sharing |
| . . . | . . . | . . . |

Besides sliding operations, such as the above-described leftward sliding and rightward sliding, other operations, such as click operations can also be set as the extension operations. By setting the preset binding relationship, the first terminal can quickly determine the extension function according to the detected extension operation, and thus the speed of displaying the extension function can be improved.

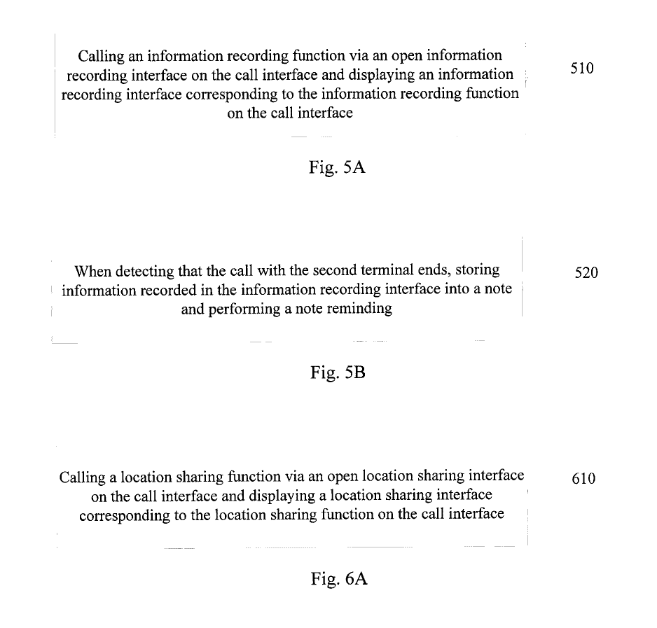

FIG. 3 is a flow chart showing an example of process 210 in FIG. 2. As shown in FIG. 3, at 310, when the extension operation is a sliding operation in a first direction, a first extension function is determined as the extension function according to the preset binding relationship between extension functions and corresponding extension operations. At 320, when the extension operation is a sliding operation in a second direction, a second extension function is determined as the extension function according to the preset binding relationship between extension functions and corresponding extension operations.

In some embodiments, the first direction and the second direction can be, for example, left and right, respectively, and correspondingly the sliding operation in the first direction and the sliding operation in the second direction can be the leftward sliding and the rightward sliding, respectively. In some embodiments, the first extension function is the information recording function and the second extension function is the location sharing function. In some embodiments, the first extension function is the location sharing function and the second extension function is the information recording function.

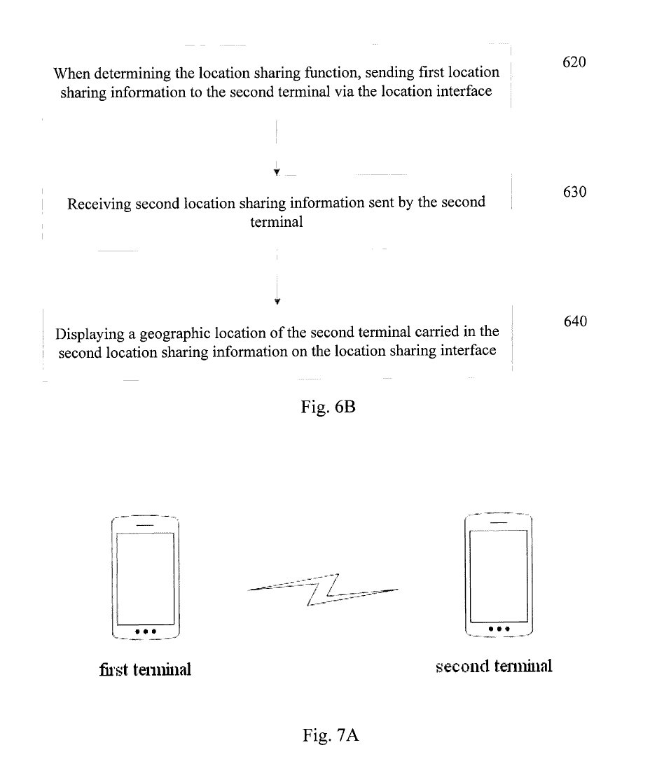

FIG. 4 is a flow chart showing an example of process 130 in FIG. 1. As shown in FIG. 4, at 410, the extension function is called via an open extension function interface on the call interface and the application interface corresponding to the extension function is displayed on the call interface. The application interface includes an extension portal, which is configured to execute the corresponding extension function.

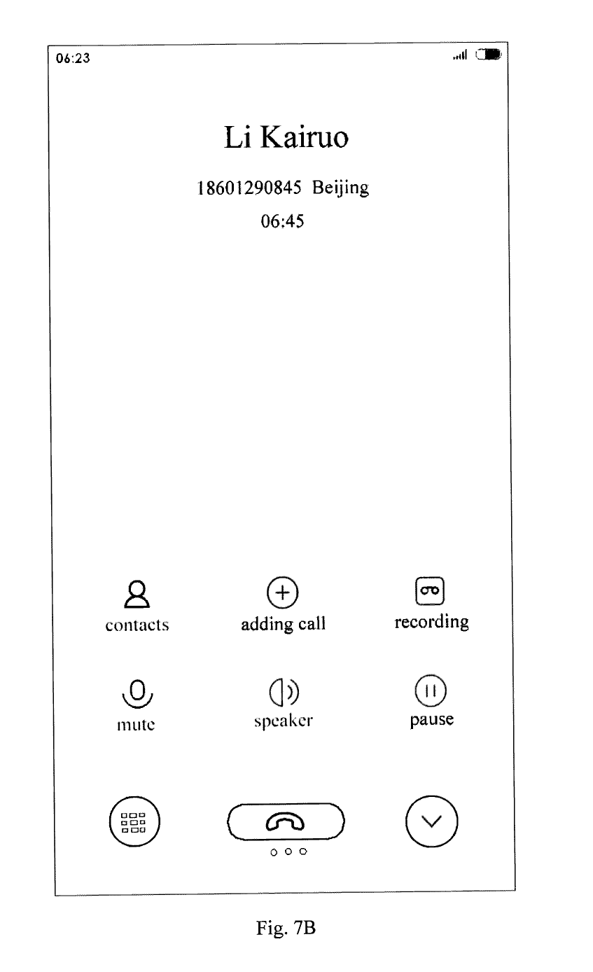

FIG. 5A is a flow chart showing an example of process 410 in FIG. 4. In this example, the determined extension function is the information recording function. As shown in FIG. 5A, at 510, the information recording function is called via an open information recording interface on the call interface and an information recording interface corresponding to the information recording function is displayed on the call interface.

FIG. 5B is a flow chart showing an additional process after the process 510 in FIG. 5A according to an exemplary embodiment. As shown in FIG. 5B, at 520, after it is detected that the call with the second terminal ends, information recorded in the information recording interface is stored in a note, and a note reminding is performed.

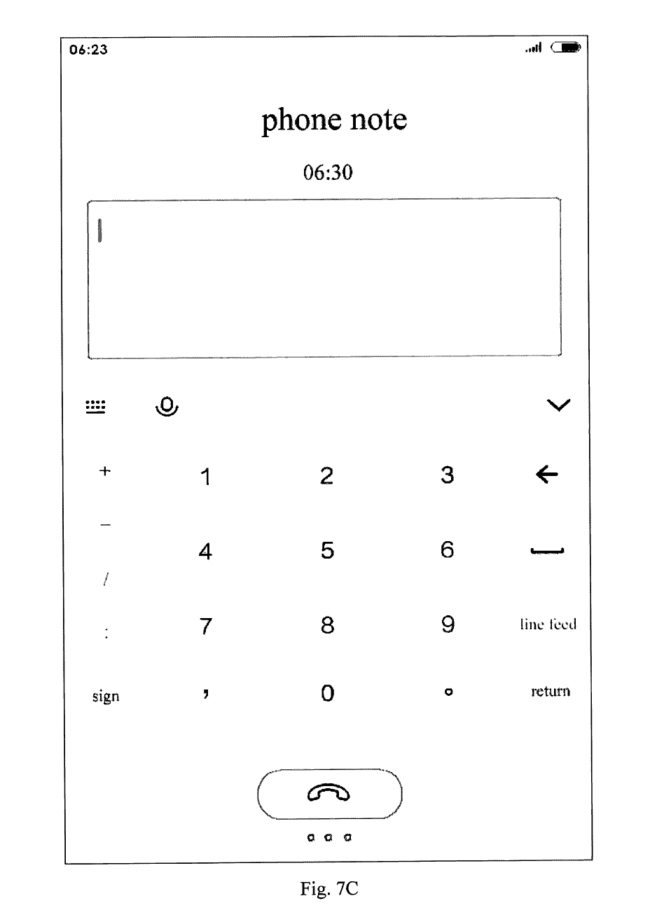

FIG. 6A is a flow chart showing another example of process 410 in FIG. 4. In this example, the determined extension function is the location sharing function. As shown in FIG. 6A, at 610, the location sharing function is called via an open location sharing interface on the call interface and a location sharing interface corresponding to the location sharing function is displayed on the call interface.

FIG. 6B is a flow chart showing additional processes after process 610 in FIG. 6A according to an exemplary embodiment. As shown in FIG. 6B, at 620, when the location sharing function is determined, first location sharing information is sent to the second terminal via the location sharing interface. The first location sharing information carries a geographic location of the first terminal.

At 630, second location sharing information sent by the second terminal is received. The second location sharing information carries a geographic location of the second terminal.

At 640, the geographic location of the second terminal is displayed on the location sharing interface.

The above processes 620-640 do not have to be all performed. In some embodiments, after the location sharing interface is displayed on the call interface, process 620 is executed, and the process flow ends. In some embodiments, after the location sharing interface is displayed on the call interface, processes 630 and 640 are executed, and the process flow ends.

In some embodiments, before the geographic location of the second terminal is displayed, a sharing prompt can he performed according to the second location sharing information. The sharing prompt includes options to accept sharing or refuse sharing. When the user's selection of accepting sharing is received, the geographic location of the second terminal is displayed on the location sharing interface.

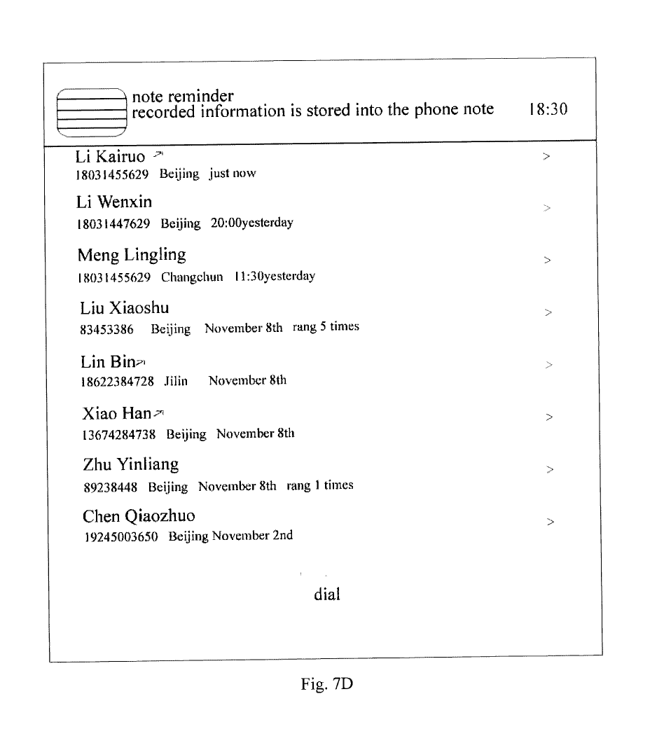

FIG. 7A is a schematic diagram showing an application scenario in which a method for function extending consistent with the present disclosure can be implemented. The application scenario includes the first terminal and the second terminal.

After receiving the call from the second terminal, the first terminal displays the call interface for the call with the second terminal. FIG. 7B shows an exemplary call interface. If the user needs to record information, the user performs a leftward sliding operation on the call interface. When the first terminal detects the leftward sliding operation, the first terminal determines the information recording function as the corresponding extension function according to the leftward sliding operation, and displays the information recording interface, for example, the phone note, corresponding to the information recording function on the call interface. FIG. 7C shows an exemplary information recording interface. The user can input the information to be recorded in the information recording interface.

When detecting that the call with the second terminal ends, the first terminal stores the information recorded in the information recording interface into a note and prompts a note reminder. FIG. 7D shows an exemplary note reminder.

On the other hand, if the user needs location sharing, the user performs a rightward sliding operation on the call interface. When the first terminal detects the rightward sliding operation, the first terminal determines the location sharing function as the corresponding extension function according to the rightward sliding operation, and displays the location sharing interface corresponding to the location sharing function on the call interface. The location sharing interface includes the location information of the first terminal and a location sharing portal. FIG. 7E shows an exemplary location sharing interface, which includes a map for showing the location information of the first terminal.

The first terminal receives the second location sharing information sent by the second terminal and performs a sharing prompt according to the second location sharing information. The second location sharing information includes the geographic location of the second terminal, and the sharing prompt includes whether to accept sharing or refuse sharing. FIG. 7F shows an exemplary sharing prompt displayed on the call interface.

When the user determines to accept sharing, the geographic location of the second terminal is displayed on the location sharing interface. FIG. 7G shows the exemplary location sharing interface with the geographic location of the second terminal marked in a map displayed in the location sharing interface.

Exemplary devices for function extending consistent with the present disclosure are described below. As noted above, devices consistent with the present disclosure can be implemented, for example, in the first terminal, which can be in a voice call session with the second terminal. Operations of the exemplary devices are similar to the above-described exemplary methods, and thus their detailed description is omitted here.

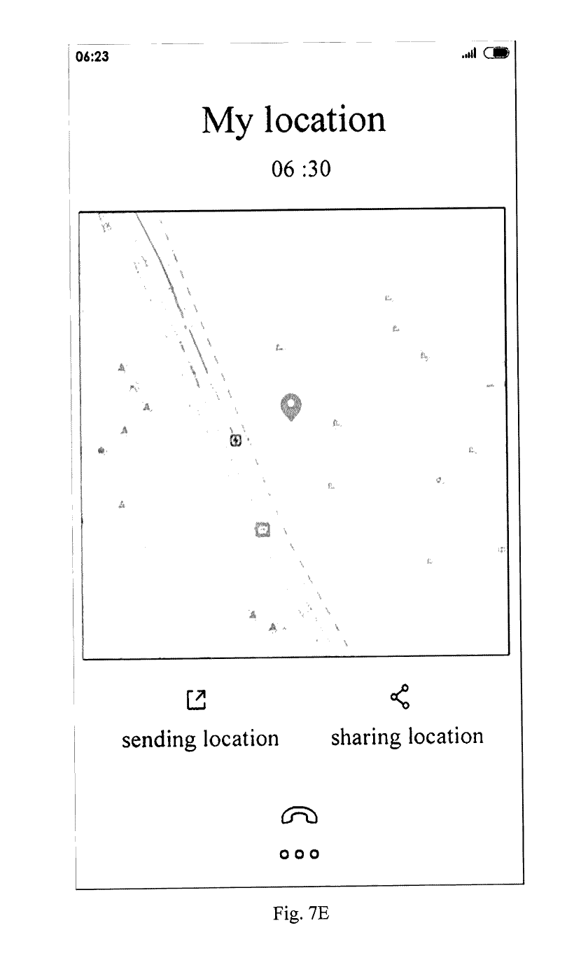

FIG. 8 is a block diagram of a device 800 for function extending according to an exemplary embodiment. As shown in FIG. 8, the device 800 includes a first displaying module 801, an extension function determining module 802, and a second displaying module 803. The first displaying module 801 is configured to display a call interface for a voice call with the second terminal. The extension function determining module 802 is configured to determine a corresponding extension function when an extension operation performed by a user on the call interface is detected. The second displaying module 803 is configured to display an application interface corresponding to the extension function on the call interface.

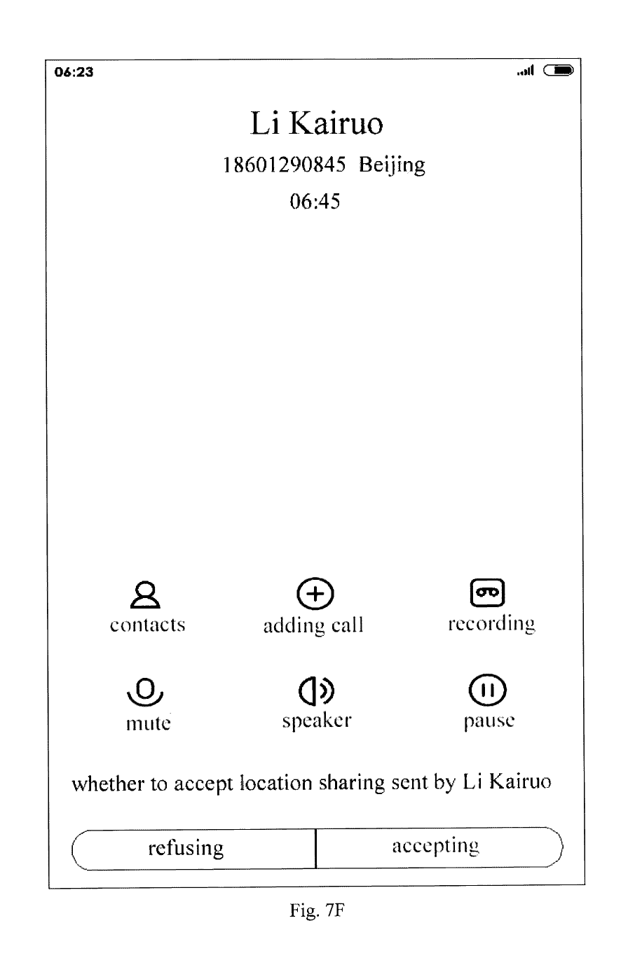

FIG. 9A is a block diagram showing an example of the extension function determining module 802. As shown in FIG. 9A, the extension function determining module 802 includes an extension function determining sub-module 901. The extension function determining sub-module 901 is configured to determine the corresponding extension function according to a preset binding relationship between extension functions and corresponding extension operations, when the extension operation by the user on the call interface is detected.

FIG. 9B is a block diagram of a device 900 for function extending according to another exemplary embodiment. As shown in FIG. 9B, the device 900 includes the first displaying module 801, the extension function determining module 802 including the extension function determining sub-module 901, the second displaying module 803, a first setting module 902, a second setting module 903, and a binding module 904. The first setting module 902 is configured to set at least one extension function. The second setting module 903 is configured to set the extension operation corresponding to each of the at least one extension function. The binding module 904 is configured to bind each of the extension function with the corresponding extension operation, to obtain the preset binding relationship between extension functions and corresponding extension operations.

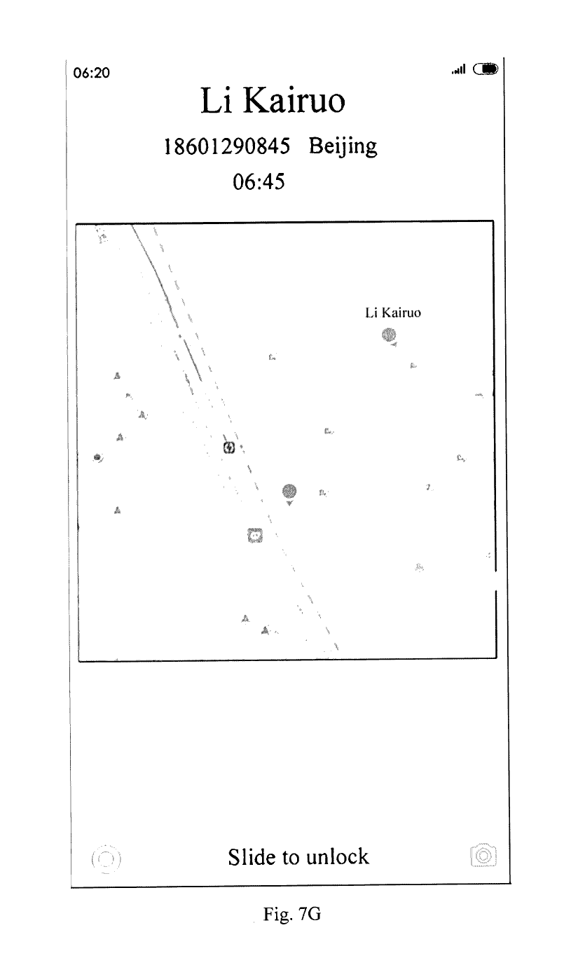

FIG. 10 is a block diagram of an example of the extension function determining sub-module 901 in FIG. 9A. As shown in FIG. 10, the extension function determining sub-module 901 includes a first extension function determining unit 1001 and a second extension function determining unit 1002. The first extension function determining unit 1001 is configured to determine a first extension function as the extension function according to the preset binding relationship when the extension operation is a sliding operation in a first direction. The second extension function determining unit 1002 is configured to determine a second extension function as the extension function according to the preset binding relationship when the extension operation is a sliding operation in a second direction. The first and second directions can be, for example, left and right, respectively, and correspondingly the sliding operation in the first direction and the sliding operation in the second direction can be leftward sliding and rightward sliding, respectively. In some embodiments, the first extension function is an information recording function and the second extension function is a location sharing function. In some embodiments, the first extension function is the location sharing function and the second extension function is the information recording function.

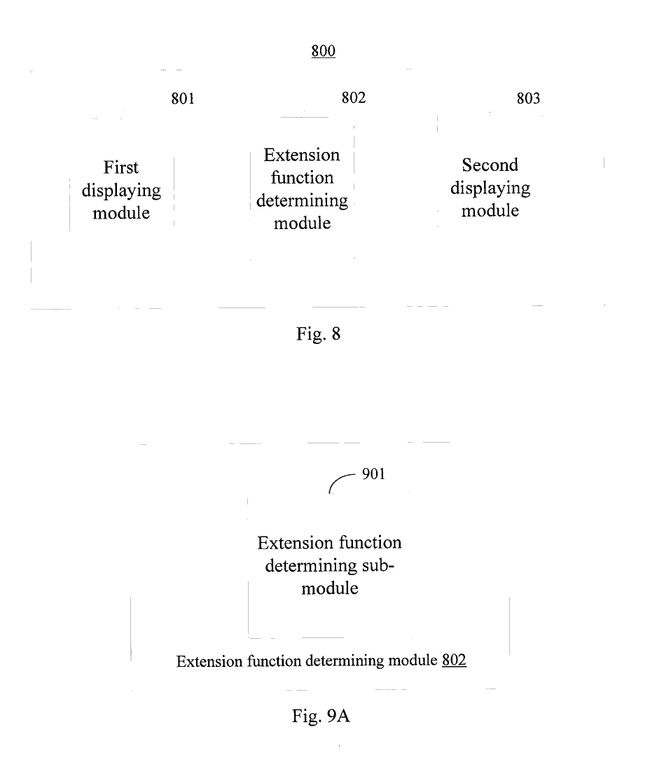

FIG. 11 is a block diagram showing an example of the second displaying module 803 in FIG. 8. As shown in FIG. 11, the second displaying module 803 includes a displaying sub-module 1101. The displaying sub-module 1101 is configured to call the extension function via an open extension function interface on the call interface and to display the application interface corresponding to the extension function on the call interface.

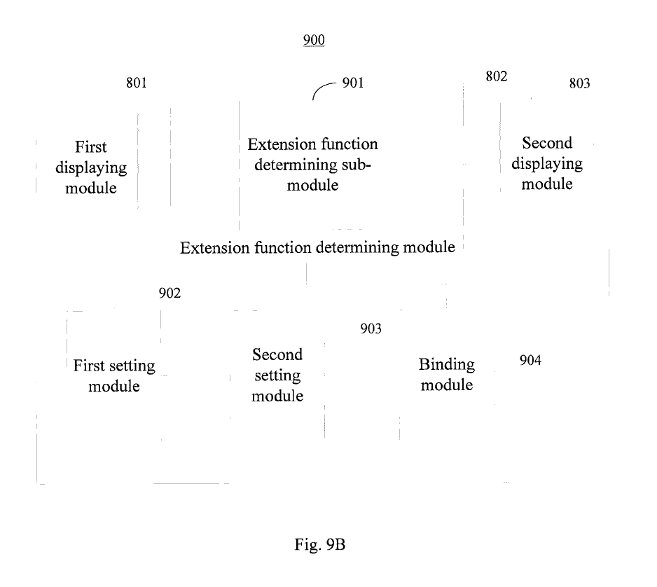

FIG. 12A is a block diagram showing an example of the displaying sub-module 1101 in FIG. 11. In this example, the determined extension function is the information recording function. As shown in FIG. 12A, the displaying sub-module 1101 includes a first displaying unit 1201. The first displaying unit 1201 is configured to call the information recording function via an open information recording interface on the call interface and to display the information recording interface corresponding to the information recording function on the call interface.

FIG. 12B is a block diagram showing another example of the displaying sub-module 1101. As shown in FIG. 12B, the displaying sub-module 1101 includes the first displaying unit 1201 and a storing unit 1202. The storing unit 1202 is configured to store information recorded in the information recording interface into a note and to perform a note reminding when it is detected that the call with the second terminal ends.

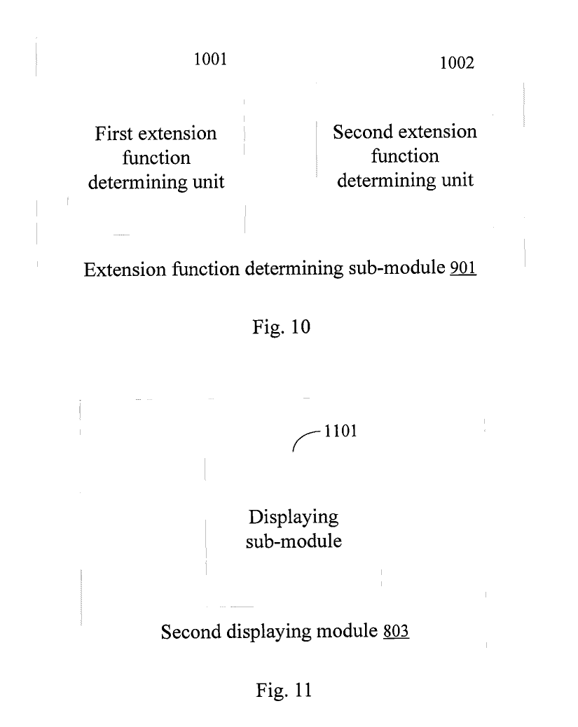

FIG. 13 is a block diagram showing another example of the displaying sub-module 1101. In this example, the determined extension function is the location sharing function. As shown in FIG. 13, the displaying sub-module 1101 includes a second displaying unit 1301. The second displaying unit 1301 is configured to call the location sharing function via an open location sharing interface on the call interface and to display the location sharing interface corresponding to the location sharing function on the call interface.

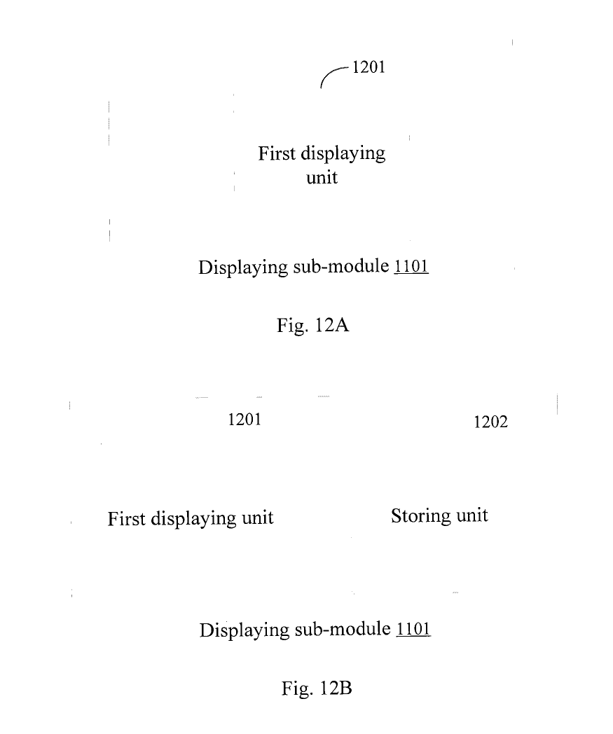

FIG. 14 is a block diagram showing another example of the displaying sub-module 1101. As shown in FIG. 14, the displaying sub-module 1101 includes the second displaying unit 1301 and a sending unit 1401. The sending unit 1401 is configured to send first location sharing information to the second terminal via the location sharing interface when location sharing is determined. The first location sharing information carries a geographic location of the first terminal.

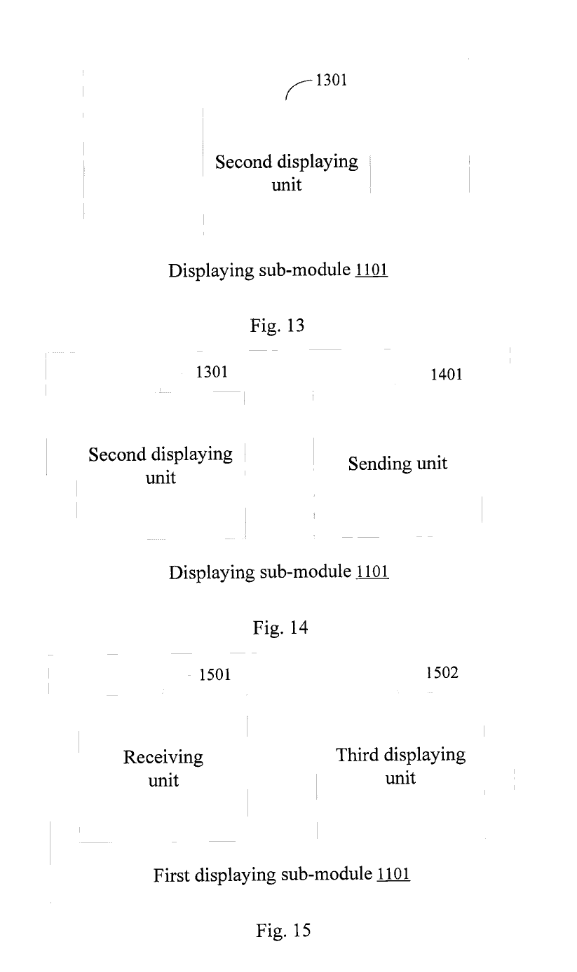

FIG. 15 is a block diagram showing another example of the displaying sub-module 1101. As shown in FIG. 15, the displaying sub-module 1101 includes a receiving unit 1501 and a third displaying unit 1502. The receiving unit 1501 is configured to receive second location sharing information sent by the second terminal. The second location sharing information carries a geographic location of the second terminal. The third displaying unit 1502 is configured to display the geographic location of the second terminal on the location sharing interface.

In some embodiments, the displaying sub-module 1101 includes the second displaying unit 1301, the receiving unit 1501, and the third displaying unit 1502. In some embodiments, the displaying sub-unit 1101 further includes the second displaying unit 1301, the sending unit 1401, the receiving unit 1501, and the third displaying unit 1502

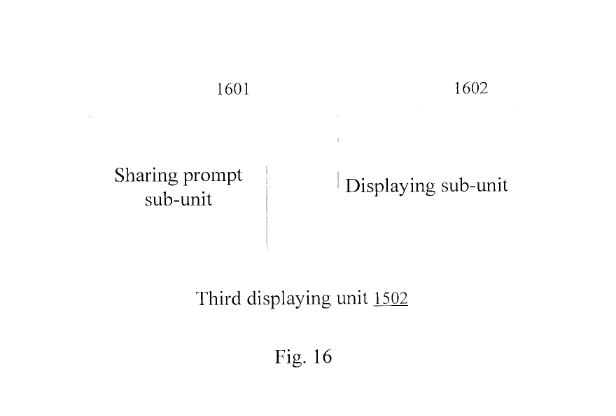

FIG. 16 is a block diagram showing an example of the third displaying unit 1502. As shown in FIG. 16, the third displaying unit 1502 includes a sharing prompt sub-unit 1601 and a displaying sub-unit 1602. The sharing prompt sub-unit 1601 is configured to perform a sharing prompt according to the second location sharing information. The sharing prompt includes options to accept sharing or refuse sharing. The displaying sub-unit 1602 is configured to display the geographic location of the second terminal on the location sharing interface when accepting sharing is determined.

According to the present disclosure, there is provided a device for function extending. The device can be implemented, for example, in the first terminal, and includes a processor and a memory storing instructions executable by the processor. The processor is configured to perform a method consistent with the present disclosure, such as one of the above-described exemplary methods.

The above-described exemplary devices are merely for the purpose of illustration. Modules and units described as separate components may be or may not be physically separated. A module or a unit shown as one component may be or may not be a physical component, i.e., the module or unit can either be located at one place or be distributed onto a plurality of network components. The above-described exemplary methods can be practiced by part or all of modules and/or units in accordance with practical requirements.

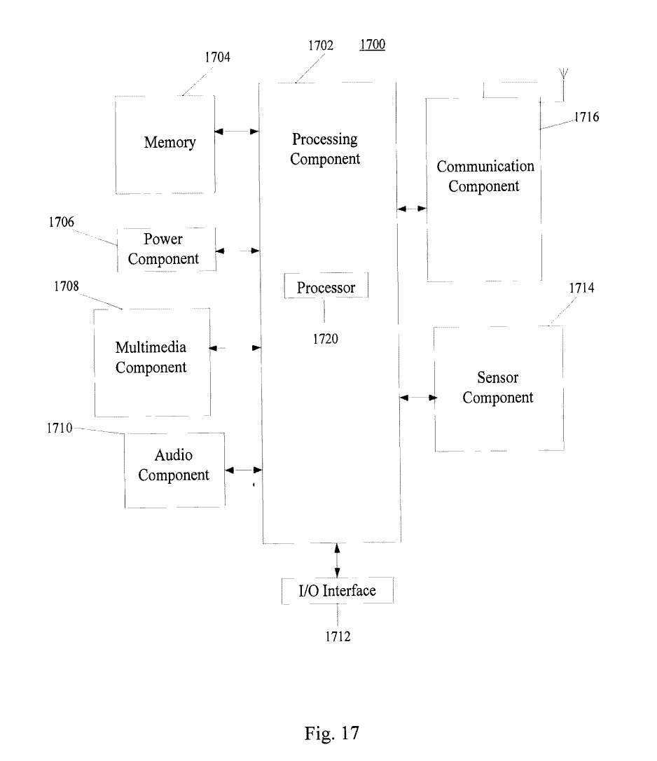

FIG. 17 is a block diagram of a terminal 1700 for function extending according to an exemplary embodiment. For example, the terminal 1700 may be a mobile phone, a computer, a digital broadcast terminal, a messaging device, a gaming console, a tablet, a medical device, exercise equipment, a personal digital assistant, or the like.

Referring to FIG. 17, the terminal 1700 includes one or more of the following components: a processing component 1702, a memory 1704, a power component 1706, a multimedia component 1708, an audio component 1710, an input/output (I/O) interface 1712, a sensor component 1714, and a communication component 1716.

The processing component 1702 typically controls overall operations of the terminal 1700, such as the operations associated with display, telephone calls, data communications, camera operations, and recording operations. The processing component 1702 may include one or more processors 1720 to execute instructions to perform all or part of a method consistent with the present disclosure, such as one of the above-described exemplary methods. Moreover, the processing component 1702 may include one or more modules which facilitate the interaction between the processing component 1702 and other components. For instance, the processing component 1702 may include a multimedia module to facilitate the interaction between the multimedia component 1708 and the processing component 1702.

The memory 1704 is configured to store various types of data to support the operation of the terminal 1700. Examples of such data include instructions for any applications or methods operated on the terminal 1700, contact data, phonebook data, messages, pictures, video, etc. The memory 1704 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 1706 provides power to various components of the terminal 1700. The power component 1706 may include a power management system, one or more power sources, and any other components associated with the generation, management, and distribution of power in the terminal 1700.

The multimedia component 1708 includes a screen providing an output interface between the terminal 1700 and the user. In some embodiments, the screen may include a liquid crystal display (LCD) and a touch panel. If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a period of time and a pressure associated with the touch or swipe action. In some embodiments, the multimedia component 1708 includes a front camera and/or a rear camera. The front camera and/or the rear camera may receive an external multimedia datum while the terminal 1700 is in an operation mode, such as a photographing mode or a video mode. Each of the front camera and the rear camera may be a fixed optical lens system or have focus and optical zoom capability.

The audio component 1710 is configured to output and/or input audio signals. For example, the audio component 1710 includes a microphone configured to receive an external audio signal when the terminal 1700 is in an operation mode, such as a mode, a recording mode, and a voice recognition mode. The received audio signal may be further stored in the memory 1704 or transmitted via the communication component 1716. In some embodiments, the audio component 1710 further includes a speaker to output audio signals.

The I/O interface 1712 provides an interface between the processing component 1702 and peripheral interface modules, such as a keyboard, a click wheel, buttons, and the like. The buttons may include, but are not limited to, a home button, a volume button, a starting button, and a locking button.

The sensor component 1714 includes one or more sensors to provide status assessments of various aspects of the terminal 1700. For instance, the sensor component 1714 may detect an open/closed status of the terminal 1700, relative positioning of components, e.g., the display and the keypad, of the terminal 1700, a change in position of the terminal 1700 or a component of the terminal 1700, a presence or absence of user contact with the terminal 1700, an orientation or an acceleration/deceleration of the terminal 1700, and a change in temperature of the terminal 1700. The sensor component 1714 may include a proximity sensor configured to detect the presence of nearby objects without any physical contact. The sensor component 1714 may also include a light sensor, such as a CMOS or CCD image sensor, for use in imaging applications. In some embodiments, the sensor component 1714 may also include an accelerometer sensor, a gyroscope sensor, a magnetic sensor, a pressure sensor, or a temperature sensor.

The communication component 1716 is configured to facilitate communication, wired or wirelessly, between the terminal 1700 and other devices. The terminal 1700 can access a wireless network based on a communication standard, such as WiFi, 2G, 3G, or 4G, or a combination thereof. In one exemplary embodiment, the communication component 1716 receives a broadcast signal or broadcast associated information from an external broadcast management system via a broadcast channel. In one exemplary embodiment, the communication component 1716 further includes a near field communication (NFC) module to facilitate short-range communications. For example, the NFC module may be implemented based on a radio frequency identification (RFID) technology, an infrared data association (IrDA) technology, an ultra-wideband (UWB) technology, Bluetooth technology, or another technology.

In exemplary embodiments, the terminal 1700 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing a method consistent with the present disclosure, such as one of the above-described exemplary methods.

In exemplary embodiments, there is also provided a non-transitory computer-readable storage medium including instructions, such as included in the memory 1704, executable by the processor 1720 in the terminal 1700, for performing a method consistent with the present disclosure, such as one of the above-described exemplary methods. For example, the non-transitory computer-readable storage medium may be a ROM, a RAM, a CD-ROM, a magnetic tape, a floppy disc, an optical data storage device, or the like.

According to the present disclosure, an application interface corresponding to an extension function can be directly displayed on a call interface of a terminal upon detecting an extension operation performed by a user of the terminal during a voice call. The user can then directly perform further operations on the displayed application interface. As a result, the user does not need to switch from the call interface to another application interface, which is convenient for the user and simplifies the user operation. Further, the user's personalized needs can be satisfied and the user experience can be improved.

Other embodiments of the disclosure will be apparent to those skilled in the art from consideration of the specification and practice of the present disclosure. This application is intended to cover any variations, uses, or adaptations of the invention following the general principles thereof and including such departures from the present disclosure as come within known or customary practice in the art. It is intended that the specification and examples be considered as exemplary only, with a true scope and spirit of the invention being indicated by the appended claims.

It will be appreciated that the present invention is not limited to the exact construction that has been described above and illustrated in the accompanying drawings, and that various modifications and changes can be made without departing from the scope thereof. It is intended that the scope of the invention only be limited by the appended claims.

What is claimed is:

1. A method for function extending, comprising:
displaying a call interface on a first terminal for a voice call with a second terminal;
determining an extension function when detecting an extension operation performed on the call interface; and
displaying an application interface corresponding to the extension function on the call interface.

2. The method according to claim 1, wherein determining the extension function includes:
determining the extension function according to a preset binding relationship between at least one extension function and at least one extension operation.

3. The method according to claim 2, further comprising:
setting a candidate extension function;
setting a candidate extension operation corresponding to the candidate extension function; and
binding the candidate extension function with the candidate extension operation to obtain the preset binding relationship.

4. The method according to claim 2, wherein determining the extension function includes:
determining, when the extension operation includes a sliding operation in a first direction, an information recording function as the extension function; and
determining, when the extension operation includes a sliding operation in a second direction, a location sharing function as the extension function.

5. The method according to claim 1, further comprising, before displaying the application interface:
calling the extension function via an open extension function interface on the call interface.

6. The method according to claim 5, wherein:
calling the extension function via the open extension function interface includes calling an information recording function via an open information recording interface on the call interface, and
displaying the application interface includes displaying an information recording interface corresponding to the information recording function on the call interface.

7. The method according to claim 6, further comprising, after displaying the information recording interface:
storing information recorded in the information recording interface into a note; and
performing a note reminding when detecting that the voice call with the second terminal ends.

8. The method according to claim 5, wherein:
calling the extension function via the open extension function interface includes calling a location sharing function via an open location sharing interface on the call interface, and
displaying the application interface includes displaying a location sharing interface corresponding to the location sharing function on the call interface.

9. The method according to claim 8, further comprising, after displaying the location sharing interface:
sending location sharing information to the second terminal via the location sharing interface when receiving an instruction to share location, the location sharing information carrying a geographic location of the first terminal.

10. The method according to claim 8, further comprising, after displaying the location sharing interface:
receiving location sharing information sent by the second terminal, the location sharing information carrying a geographic location of the second terminal; and
displaying the geographic location of the second terminal on the location sharing interface.

11. The method according to claim 10, wherein displaying the geographic location of the second terminal includes:
performing a sharing prompt according to the location sharing information, the sharing prompt including options to accept sharing or refuse sharing; and
displaying the geographic location of the second terminal on the location sharing interface when the option to accept sharing is selected.

12. A terminal, comprising:
a processor; and
a memory storing instructions that, when executed by the processor, cause the processor to:
display a call interface on the terminal for a voice call with another terminal;
determine an extension function when detecting an extension operation performed on the call interface; and
display an application interface corresponding to the extension function on the call interface.

13. The terminal according to claim 12, wherein the instructions further cause the processor to:
determine the extension function according to a preset binding relationship between at least one extension function and at least one extension operation.

14. The terminal according to claim 13, wherein the instructions further cause the processor to:
determine, when the extension operation includes a sliding operation in a first direction, an information recording function as the extension function; and
determine, when the extension operation includes a sliding operation in a second direction, a location sharing function as the extension function.

15. The terminal according to claim 12, wherein the instructions further cause the processor to:
call the extension function via an open extension function interface on the call interface.

16. The terminal according to claim 15, wherein the instructions further cause the processor to:
call an information recording function via an open information recording interface on the call interface, and
display an information recording interface corresponding to the information recording function on the call interface.

17. The terminal according to claim 15, wherein the instructions further cause the processor to:
call a location sharing function via an open location sharing interface on the call interface, and
display a location sharing interface corresponding to the location sharing function on the call interface.

18. The terminal according to claim 17, wherein the instructions further cause the processor to, after displaying the location sharing interface:
send location sharing information to the other terminal via the location sharing interface when receiving an instruction to share location, the location sharing information carrying a geographic location of the terminal.

19. The terminal according to claim 17, wherein the instructions further cause the processor to, after displaying the location sharing interface:
receive location sharing information sent by the other terminal, the location sharing information carrying a geographic location of the other terminal; and
display the geographic location of the other terminal on the location sharing interface.

20. A non-transitory computer-readable storage medium having stored therein instructions that, when executed by a processor of a terminal, cause the terminal to:
display a call interface on the terminal for a voice call with another terminal;
determine an extension function when detecting an extension operation performed on the call interface; and
display an application interface corresponding to the extension function on the call interface.
